(19) United States
(12) Patent Application Publication
(10) Pub. No.: US 2022/0100570 A1
(43) Pub. Date: Mar. 31, 2022

(54) WORKFLOW INITIATION BASED ON A SIMULATED NETWORK ADDRESS

(71) Applicants: Er-Xin SHANG, Shanghai (CN); Ran LI, Shanghai (CN); Hua-Ming ZHAI, Shanghai (CN); MICRO FOCUS LLC, SANTA CLARA, CA (US)

(72) Inventors: ErXin Shang, Shanghai (CN); RAN LI, Shanghai (CN); HUA-MING ZHAI, SHANGHAI (CN)

(73) Assignee: MICRO FOCUS LLC, SANTA CLARA, CA (US)

(21) Appl. No.: 17/426,066

(22) PCT Filed: Mar. 7, 2019
(86) PCT No.: PCT/CN2019/077289

§ 371 Date: Jul. 27, 2021

(51) Int. Cl. G06F 9/50; G06F 16/955

(52) U.S. Cl. CPC G06F 9/5027; G06F 16/9566

(57) ABSTRACT

According to examples, an apparatus may include a processor that may identify and execute workflows based on simulated network addresses such as simulated uniform resource locations (“URLs”). The system may generate recorded automation scripts that automatically completes some or all of the tasks of a workflow. The system may store the automation scripts in association with the workflow and a simulated URL. The simulated URL may include a string that does not literally resolve to a document on a networked resource. Rather, the simulated URL may instead identify and indicate that a corresponding workflow is to be executed. A browser extension of a browser may intercept URLs that are provided to a browser, determine that a simulated URL has been entered, and provide the simulated URL to a replay engine that identifies and executes the automated script associated with the simulated URL.

### BACKGROUND

A workflow may represent a set of discrete tasks that is to be completed in order to complete an objective of the workflow. For example, a workflow may represent a vacation request that includes a discrete set of tasks to be completed by users who wish to request a vacation. In many examples, workflows may include a set of tasks that are complex and/or time consuming to complete. Furthermore, an organization may include many workflows spread across the organization, which may make the workflows hard to find and execute.

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an example apparatus that may initiate automated workflows based on a simulated network address;

FIG. 2 shows a block diagram of a system that may record an automated script of an automated workflow;

FIG. 3 shows a block diagram of a system that may replay an automated script of an automated workflow responsive to selection of a simulated URL;

FIG. 4 depicts a flow diagram of an example method of initiating automated workflows based on a simulated network address; and

FIG. 5 depicts a block diagram of an example non-transitory machine-readable storage medium for intercepting URLs and redirecting a browser to initiate an automated workflow when an intercepted URL is a simulated URL.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other examples, some methods and structures have not been described in detail so as not to unnecessarily obscure the present disclosure.

Throughout the present disclosure, the terms “a” and “an” may be intended to denote at least one of a particular element. As used herein, the term “includes” means includes but not limited to, the term “including” means including but not limited to. The term “based on” means based at least in part on.

The disclosure relates to a system that may identify and execute workflows through simulated network addresses such as simulated uniform resource locations (“URLs”), simulated Internet Protocol (“IP”) addresses, simulated networked filesystem addresses, and/or other simulated network addresses. For example, the system may encode a simulated URL to specify a workflow to be executed. The simulated URL may include a string that does not literally resolve to a document on a networked resource such as a server. Rather, the simulated URL may instead identify a corresponding workflow is to be initiated.

The system may generate an automation script that may complete some or all of the tasks of the workflow to be initiated. For example, users may use the system to generate automation scripts and may share the automation scripts with other users via a simulated URL. The automation scripts may automatically perform tasks associated with a workflow. For example, a vacation request workflow may include tasks to be completed by a requesting user in order to request a vacation. Another user, such as a human resource (“HR”) user, may have previously recorded an automation script by performing some or all of the tasks that are applicable to all users who wish to request a vacation. An automation recorder may record the performance of the tasks and record the performance for automated execution. The tasks may include, for example, providing inputs to a graphical user interface (GUI) (such as by typing, selecting, pressing, or otherwise interaction with the GUI), initiating another application, starting a background process, and/or other task that may be recorded and later reproduced automatically. The HR user or the system may generate a simulated URL for the vacation request workflow. The system may store the simulated URL in association with the automation script. The HR user may then share the simulated URL with other users, such as either directly or as a link in an HR webpage.

When a user wishes to initiate a workflow, the user may input a simulated network address associated with the workflow into an application such as a browser of a client device. Because a simulated network address such as a simulated URL cannot be followed in the same manner as an actual network address or actual URL, the system may implement further technology improvements to modify the use of links while leveraging the ubiquity and simple mechanics of the links. For example, a client agent may be installed and executed at a client device. In a particular example, a browser extension may be installed at a web browser of the client device. The browser extension may intercept URLs input at the browser, parse the URLs, recognize/identify simulated URLs, and redirect the browser to an apparatus that replays automation scripts that execute corresponding workflows instead of literally following the simulated URL. If a parsed URL is not recognized as a simulated URL, the browser extension may simply pass the URL to the browser to follow the URL.

To illustrate, continuing the vacation request example, to request a vacation, the user may input the simulated URL into a browser of the client device. A client agent such as an extension installed at the browser may intercept the simulated URL (thereby preventing the browser from acting on the simulated URL), and may determine that the simulated URL is not an actual URL. As used herein, an actual network address or an actual URL may be defined as a functioning network address or a functioning URL, e.g., a URL corresponding to a particular document or webpage. The extension may accordingly transmit the simulated URL to a replay engine instead of passing the simulated URL to the browser. The replay engine may be on-board at the client device or may be off-board at a separate replay device that replays the automation scripts on behalf of the client device. In some examples, the browser extension may redirect the browser to the replay engine. In some examples, the browser extension may directly pass the simulated URL to the replay engine. If a parsed URL is not recognized as a simulated URL, the browser extension may simply pass the URL to the browser for browsing as usual.

The replay engine may identify the workflow and/or corresponding automation script that was previously created (such as by the HR user) and may execute the automation script, which automates some or all tasks associated with the vacation request workflow. The requesting user therefore may be able to have some or all of the tasks of the vacation request workflow automatically executed based on a predefined automation script created for the vacation request workflow.

More generally speaking, the system may provide an abstraction of workflows behind simulated network addresses that do not literally resolve to an actual network resource location. The use of simulated URLs for workflows enables easy execution of workflows and also permits updates to automation scripts that execute the workflows to be updated without having to train/retrain users on how to execute the workflows or where to find the automation scripts.

To further explain a simulated URL, an actual URL will now be described to help illustrate the difference between a simulated URL and an actual URL. An actual URL may be considered human readable location information that is used to identify an underlying network address such as an Internet Protocol (IP) address that is used to communicate with a networked resource such as a web server. An actual URL may include multiple portions, such as a protocol identifier portion, a domain name portion, a content identifier portion, a parameter input portion, a directory structure portion, and/or other portions. An actual URL may resolve to an “actual network resource location” if the literal string of the actual URL may be used to obtain content according to the following rules for protocol identifier, domain name, top-level domain name suffix, content identifier and directory structure.

To encode the network address, the actual URL may include a protocol identifier portion and a domain name portion. For example, an actual URL may include:

http://www.xyz.com

in which “http://” may be a protocol identifier portion that identifies a protocol to be used when communicating with a networked resource, “xyz” is a domain name portion that specifies a domain name, and “.com” specifies a top-level domain name suffix. The domain name may be mapped to an IP address at a Domain Name System (DNS). Together, the domain name and top-level domain name suffix may uniquely identify a specific network address.

When a web browser receives an actual URL (whether as a selected link in a web page, input via typing, a pre-stored bookmark, etc), the web browser may forward a request to obtain content from the networked resource mapped to the domain name specified by the actual URL. For example, an Internet Service Provider or other entity may receive the request, consult the DNS to identify an IP address mapped to the domain name (“xyz”) with the top-level domain suffix (“.com”) and route, to the IP address, a request to obtain content from the networked resource. The networked resource may receive the request, which may include the actual URL requested (and/or the portions of the actual URL), and identify content specified by the actual URL (and/or the portions of the actual URL). For example, in addition to the domain name, the actual URL may include content identifiers such as a document name being requested. In an example, an actual URL may include “http://www.xyz.com/sports.html,” in which the document identified by “sports.html” is requested from the domain name “xyz.” When an additional content identifier is not specified, the networked resource may provide default content such as an “index.html” document responsive to the request (for example, “http://www.xyz.com” may default to “http://www.xyz.com/index.html”).

In some examples, the content identifiers may specify a program such as a script to be executed. In these examples, an actual URL may further include parameters that are to be input to the script for execution. For example, an actual URL may include:

http://www.xyz.com/weather.py?zip=22314

in which the content identifier portion includes a content identifier “weather.py” that identifies a script to be executed by the domain name “xyz” with a parameter “zip” having a value “22314” following the “?” which may indicate that parameters follow. The zip parameter having value 22314 may be input to the weather.py script, which may generate an output based on the zip parameter input.

In some examples, an actual URL may be configured according to a directory structure of a resource that serves web pages associated with a domain. For instance, an actual URL may include:

http://www.xyz.com/sports/mlb/news.html

In this example, “sports/mlb” may correspond to a directory structure in which sports is a folder within a top-level directory of a resource that serves the domain “xyz” and “mlb” is a sub-directory or folder within “sports.” If provided in an actual URL, the directory structure may be used to identify a corresponding directory structure of a host associated with the domain name “xyz.” Such directory structure may be adhered to when retrieving requested documents. For example, the “news.html” document will be retrieved from the “mlb” subdirectory of the “sports” directory in the top-level directory of “xyz.”

A simulated URL, on the other hand, may not literally specify a network resource location. For example, the system may generate a simulated URL by modifying some or all portions of an actual URL so that the portions do not correspond to an actual document as specified in the simulated URL. In particular, the system may modify the protocol identifier, domain name, content identifier, parameters, directory structure, and/or other portions of an actual URL to generate a simulated URL, as will be described in further detail herein. A web browser that follows a simulated URL link will not be routed to a networked resource location using the routing techniques used for an actual URL.

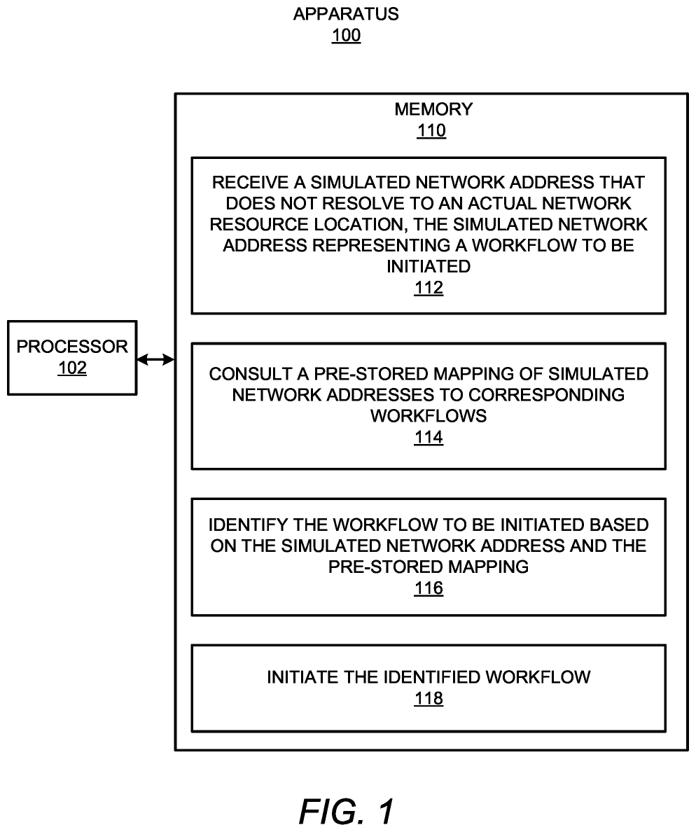

Reference is first made to FIG. 1, shows a block diagram of an example apparatus 100 that may initiate automated workflows based on a simulated network address. It should be understood that the example apparatus 100 depicted in FIG. 1 may include additional features and that some of the features described herein may be removed and/or modified without departing from any of the scopes of the example apparatus 100.

The apparatus 100 shown in FIG. 1 may be a computing device, a server, or the like. As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scopes of the apparatus 100 disclosed herein.

The apparatus 100 may include a memory 110 that may have stored thereon machine-readable instructions (which may also be termed computer readable instructions) 112-118 that the processor 102 may execute. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals. Attention will now turn to operations at processor 102 to automatically initiate workflows based on a simulated URL.

Referring to FIG. 1, the processor 102 may fetch, decode, and execute the instructions 112 to receive a simulated network address that does not resolve to an actual network resource location, the simulated network address representing a workflow to be initiated.

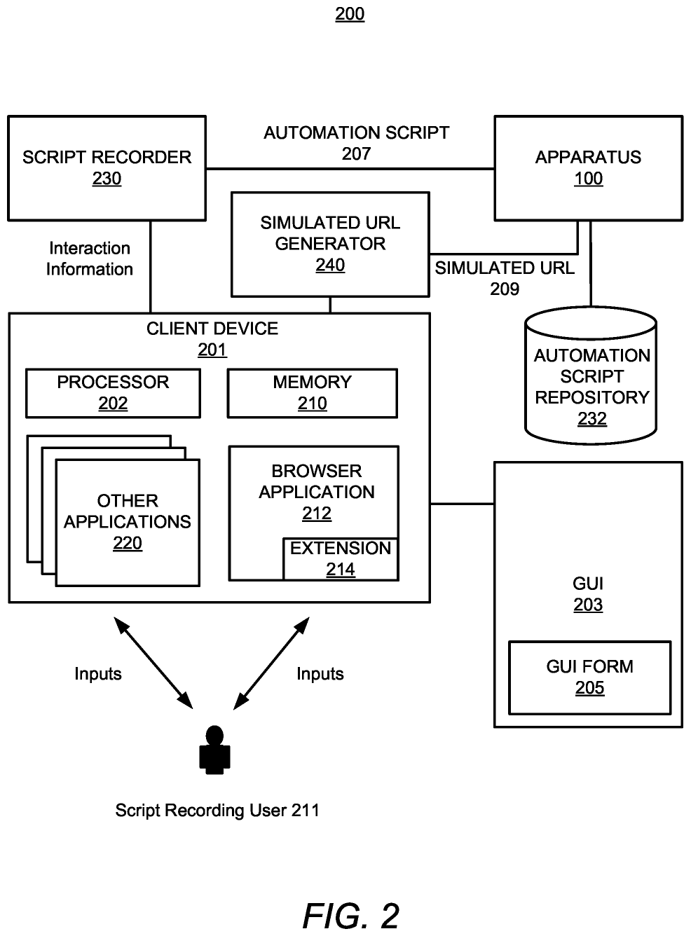

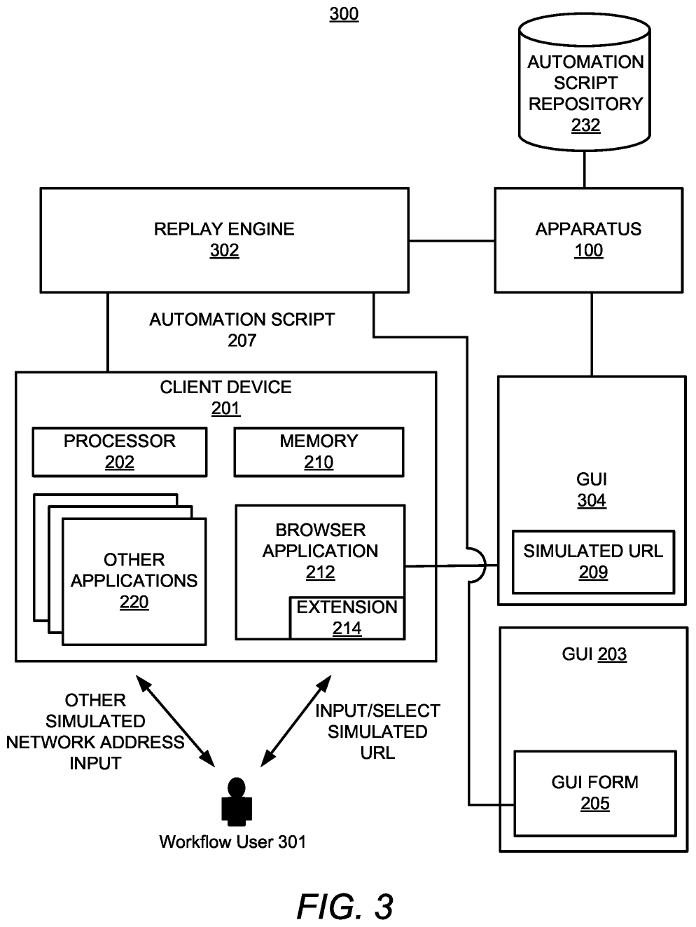

The processor 102 may fetch, decode, and execute the instructions 114 to consult a pre-stored mapping of simulated network addresses to corresponding workflows. For example, the simulated network address may be stored in association with a corresponding workflow and/or automation script 207 in the automation script repository 232 (illustrated in FIGS. 2 and 3). The processor 102 may fetch, decode, and execute the instructions 116 to identify the workflow to be initiated based on the simulated network address and the pre-stored mapping.

The processor 102 may fetch, decode, and execute the instructions 118 to initiate the identified workflow. For instance, to initiate the workflow the processor 102 may identify an automation script that automates a task to be completed in association with the workflow. The automation script may then be executed. In some examples, the simulated network address may include a parameter. In particular, the parameter may be passed as a parameter of a simulated URL. In these examples, the processor 102 may parse the parameter from the simulated network address and pass the parameter as an input to the automation script. The parameter may cause the automation script to perform various functions, such as, without limitation, automatically fill a particular GUI form field with a value of the parameter, initiate an application with the parameter as input to the application, and/or perform other functions with the parameter.

In some examples, the processor 102 may initiate the workflow by generating a GUI associated with the workflow and transmit the GUI to the client device from which the simulated network address was received. In these examples, the simulated network address may be associated with the GUI. For example, the GUI may include a webpage form that is to be filled out at the client device.

In some examples, a name of the parameter may correspond to a name of a GUI form field in the GUI form. In this way, the GUI form may automatically populate the correct GUI form field with a value of the parameter. In some examples, the automation script may execute on the client device from which the simulated network address is received. In these examples, the processor 102 may instruct the client device to execute the automation script. For example, the automation script may execute within or in association with a browser application that automatically fills in GUI form field values or may include initiation of a local application executing at the client device. Responsive to the instruction from the processor 102, the client device may execute the automation script.

FIG. 2 shows a block diagram of a system 200 that may record an automated script of an automated workflow. System 200 may include a client device 201, a script recorder 230, a simulated URL generator 240, the apparatus 100 (which is also illustrated in FIG. 1), an automation script repository 232, and/or other components. The client device 201 may include a computing device such as a personal computer, laptop, mobile phone (such as a “smartphone”), and the like. As shown in FIG. 2, the client device 201 may include a processor 202 that may control operations of the client device 201. The processor 202 may be a semiconductor-based microprocessor, a central processing unit (CPU), an application specific integrated circuit (ASIC), a field-programmable gate array (FPGA), and/or other suitable hardware device. Although the client device 201 has been depicted as including a single processor 202, it should be understood that the client device 201 may include multiple processors, multiple cores, or the like, without departing from the scopes of the client device 201 disclosed herein.

The client device 201 may include a memory 210 that may have stored thereon machine-readable instructions (which may also be termed computer readable instructions) such as a browser application 212, an extension 214 of the browser application 212, and/or other applications 220 that the processor 202 may execute. The memory 210 may be an electronic, magnetic, optical, or other physical storage device that includes or stores executable instructions. The memory 210 may be, for example, Random Access memory (RAM), an Electrically Erasable Programmable207 Read-Only Memory (EEPROM), a storage device, an optical disc, and the like. The memory 210 may be a non-transitory machine-readable storage medium, where the term “non-transitory” does not encompass transitory propagating signals.

The script recorder 230 may include hardware and/or instructions configured to record user interactions with a GUI 203. The GUI 203 may include a GUI form 205 that includes a data field for inputting or otherwise selecting data. The GUI 205 may include a web page displayed in browser application 212 or an interface of another application 220. In some examples, the script recorder 230 may be implemented as instructions that the processor 202, the processor 102 of apparatus 100, and/or other device may execute.

In some examples, the script recorder 230 may execute on an agent server device (not illustrated) that interacts with the client device 201. These examples may be implemented when the client device 201 has not met processing or other computing requirements for script recording. By way of example in which the client device 201 is a mobile phone, the mobile phone may have insufficient computational, storage, or other requirements, and the agent server device may host the script recorder 230. In this example, the client device 201 may communicate to the agent server device, information indicating user interactions with an application such as the GUI 203. It should be noted that in some examples, a mobile phone or other type of client device 201 may have sufficient requirements and may execute the script recorder 230.

Regardless of where the script recorder 230 executes, the script recorder 230 may access a user interaction with an application. For example, the script recorder 230 may record interactions with the GUI 203. In particular, the script recorder 230 may record a type of input interacted with, a value that was input or selected, buttons selected, and/or other interactions. In some examples, the script recorder 230 may record a sequence of such interactions. The script recorder 230 may record the interactions by generating an automation script 207. As will be described herein, the automation script 207 may be replayed later by the same or different user to automatically perform the same or similar interactions. For example, the automation script 207 may be used to automatically fill in certain fields of the GUI 203 as recorded in the automation script 207. The foregoing may eliminate repetitive data entry specifically for a particular user and/or repetitive data entry for all users or groups users (such as a current date entry, a department name entry, and/or other logistics information required by a workflow and common to a group or all users).

In various examples, because some fields may be specific for a specific user, such as a range of dates requested for a vacation request workflow, the script recorder 230 may provide facilities to start or stop recording. For example, the extension 214 of the browser application 212 may provide an interface to start or stop recording interactions of a GUI 203 presented through the browser 212. Similar functionality may be provided by other applications 220 as well. In this manner, the script recording user 211 may start and stop recording at appropriate times. For example, the script recording user 211 may start recording for data entry that is common to a group or all users, but may stop recording when filling out user-specific information. Although various examples of automation scripts 207 are described herein with respect to entry of data into GUI form 205, other types of interactions such as command line interface (CLI) interactions may be recorded as well.

The script recorder 230 may provide the automation script 207 to the apparatus 100. For example, the script recorder 230 may transmit the automation script 207 (or a location of where to access the automation script 207), an identification of the workflow, task, application (such as GUI 203) to which the automation script 207 pertains, an identity of the script recording user 211, the simulated URL 209 (for examples in which the apparatus 100 does not generate the simulated URL 209), and/or other information relating to the automation script 207. The apparatus 100 may store the automation script 207 in association with the workflow and/or other information in the automation script repository 232.

The simulated URL generator 240 may include hardware and/or instructions that may generate a simulated URL 209. In some examples, the simulated URL generator 240 may be implemented as instructions that the processor 202, the processor 102 of apparatus 100, and/or other device may execute. In some examples, the simulated URL generator 240 may execute on an agent server device (not illustrated) that interacts with the client device 201.

In some examples, a script recording user 211 or other user may generate a simulated URL 209 for the workflow. In these examples, the simulated URL generator 240 may verify that the simulated URL 209 is not an actual URL and will not resolve to an actual network address. For example, the simulated URL generator 240 may verify that the simulated URL 209 follows rules that specify simulated URLs. The simulated URL generator 240 may alternatively use these rules to generate the simulated URL 209.

The simulated URL 209 may be generated to be distinguishable from an actual URL but be human-understandable and memorable such as an actual URL, but not literally resolve to the simulated URL 209 itself. For example, the protocol portion, domain name portion, parameter portion, and/or other portions of an actual URL may be modified to generate a simulated URL 209 so long as a simulated URL 209 may be distinguished from an actual URL. In a particular example, a simulated URL 209 may be generated such as “wf://vacation” in which “wf://” specifies that the string refers to a simulated URL 209 that initiates a “vacation” workflow. In this example, the “wf://” may distinguish the simulated URL 209 from an actual URL.

Alternatively, or additionally, the rules may specify that a domain name portion of a simulated URL 209 is limited to certain “domain names” reserved for simulated URLs 209. For instance, the domain name “xyz” may be reserved for simulated URLs 209, assuming that xyz is not a valid domain name. In this case, the domain name “xyz” may distinguish the simulated URL 209 from an actual URL. Alternatively, or additionally, the rules may specify that certain content identifiers be used for simulated URLs 209. Any combination of these and other portions of a URL may be modified to generate a simulated URL 209. In some examples, the protocol identifier and domain name may be an actual protocol identifier and an actual domain name, but other portions of the simulated URL 209 do not resolve to an actual network resource location. For example, in the simulated URL 209: “http://www.abc.com/workflow/vacation”, the “http://www.abc.com” may resolve to an actual resource that serves the “abc” domain name but some or all of the remaining portions (such as “workflow/vacation” or simply “vacation”) may not. In these instances, some or all of the remaining portions may be reserved for a simulated URL 209 that is associated with a workflow. For instance, “workflow” may distinguish the simulated URL 209 from an actual URL, but may not be a directory or file location of the resource that serves the domain “abc.”

In some examples, the rules may require a simulated URL 209 to include a certain unique string (which may still be easy to memorize but will be distinguishable from a protocol portion of an actual URL).

In some examples, the rules may specify that a portion of a simulated URL 209 be used to identify a specific workflow. For instance, different simulated URLs 209 may be encoded as: “xyz.com/workflows/vacation” and ““xyz.com/workflows/time-entry.” The “/workflows” portion may indicate that the URL is a simulated URL 209 referring to workflows. The “/vacation” and “Rime-entry” portions may respectively identify a vacation request workflow and a time-entry workflow. Different types of workflows may be similarly defined. Other portions of a simulated URL 209 may be used to identify workflows as well, such as based on a parameter input such as “xyz.com/workflow.py?type=vacation” and “xyz.com/workflow.py?type=time-entry.”

TABLE 1
Table 1 illustrates an example of a workflow, simulated URL that
may be used to initiate the workflow, tasks to be completed for
the workflow, and automation scripts 207 that may be available
to complete some or all of the tasks. Although only one workflow
is illustrated, others may be included as well. Furthermore,
the information presented in Table 1 is for illustrative purposes.
Other types of data and arrangements of data may be used as well.
The example data row illustrated in Table 1 may represent an
entry in the automation script repository 232.

| | | | Automation |
|---|---|---|---|
| Workflow | Simulated URL | Task(s) | script(s) |
| Vacation | www.xyz.com/ | Submit | Automation |
| Request | workflows/vacation | requested | script 1 |
| | | dates, | |
| | | department, | |
| | | current date, | |
| | | etc. | |

Once an automation script 207 and simulated URL 209 are generated, the script recording user 211 may share the automation script 207 and/or the workflow to other users via the simulated URL 209. The other users may select or input the simulated URL 209 to access the automation script 207 and/or workflow for automated execution, as will now be described with reference to FIG. 3.

FIG. 3 shows a block diagram of a system 300 that may replay an automated script of an automated workflow responsive to selection of a simulated URL. System 300 may include the client device 201 (also illustrated in FIG. 2), the apparatus 100 (also illustrated in FIGS. 1 and 2), the automated script repository 232 (also illustrated in FIG. 2), a replay engine 302, and/or other components.

A workflow user 301 may receive a shared simulated URL 209, be presented with the shared simulated URL 209 in a GUI 304, access a pre-stored listing of simulated URLs that includes the simulated URL 209 (such as bookmarks of the simulated URLs 209 of a browser application 212), or otherwise access the simulated URL 209. The browser application 212 (or other applications 220) of the client device 201 may receive an input of the simulated URL 209. For example, the browser application 212 may receive a typed input, a link selection, a bookmark selection, or other type of input of the simulated URL 209 from the workflow user 301.

In some examples, the extension 214 may intercept the simulated URL 209. For instance, the extension 214 may intercept all URLs inputted at the browser application 212 to determine whether the inputted URLs are simulated URLs or actual URLs. To do so, in some examples, the extension 214 may access the rules for generating simulated URLs in order to parse the inputted URLs. For example, if the rule specifies that a reserved protocol identifier is to be used for simulated URLs and the inputted URL includes the reserved protocol identifier, then the extension 214 may determine that the inputted URL is a simulated URL 209. Other rules may additionally or alternatively be consulted for parsing inputted URLs to determine whether the inputted URLs are simulated URLs or actual URLs.

When the extension 214 determines that the inputted URL is a simulated URL 209, the extension 214 may cause a request to be transmitted to the apparatus 100 instead of literally using the inputted URL. In some examples, the request may include a redirect of the browser application 212 from the inputted URL to an appropriate network address. In some examples, the request may be transmitted directly from the extension 214. In either of these examples, the extension 214 may store the appropriate network address (such as a network address of a web service provided by the apparatus 100) for use with simulated URLs and either redirect the browser application 212 to the network address or transmit the request directly to the network address. Alternatively, if the rules permit use of an actual domain name, the extension 214 may cause a request to be transmitted to the appropriate network address—such as the web service of the apparatus 100—associated with the domain name. In this example, the domain name may process simulated URLs 209. It should be noted that the other applications 220 may be programmed to operate in a similar manner as the browser application 212 and the extension 214.

When the apparatus 100 receives the request from the browser application 212 or extension 214, the apparatus 100 may consult the automation script repository to identify a workflow and an automation script 207 associated with the simulated URL 209. The apparatus 100 may provide the automation script 207 to the replay engine 302. In some examples, the replay engine 302 may be implemented as instructions that the processor 202, the processor 102 of apparatus 100, and/or other device may execute.

The replay engine 302 may replay the recorded automation script 207. For example, the apparatus 100 may provide, responsive to the request from the browser application 212 or extension 214, the GUI 203 having the GUI form 205 to the browser application 212. The replay engine 302 (which may operate on the client device 201, apparatus 100, or a separate replay device (not illustrated)), may replay the automation script 207 to automatically fill appropriate fields as originally recorded (such as by the script recording user 211 illustrated in FIG. 2). In this manner, the system 300 may automatically initiate the workflow responsive to input of a simulated URL 209 at the browser application 212 or other applications 220. It should be noted that the automation script 207 may alternatively or additionally include backend processing operations to be executed. For example, the replay engine 302 may initiate backend processing operations associated with the workflow. Such backend processing operations (or resulting outputs) may be visible or not visible to the workflow user 301. For example, the backend processing operations may include initiating an application, executing a script, generating alerts to relevant personnel, creating workflow assignments such as tasks to be completed by relevant personnel, automatically populate database entries associated with the workflow, and/or other operations that may or may not be indicated to the workflow user 301 through the GUI 203 or otherwise. In some instances, the replay engine 302 may provide an instruction to the client device 201 to initiate the backend processing operation.

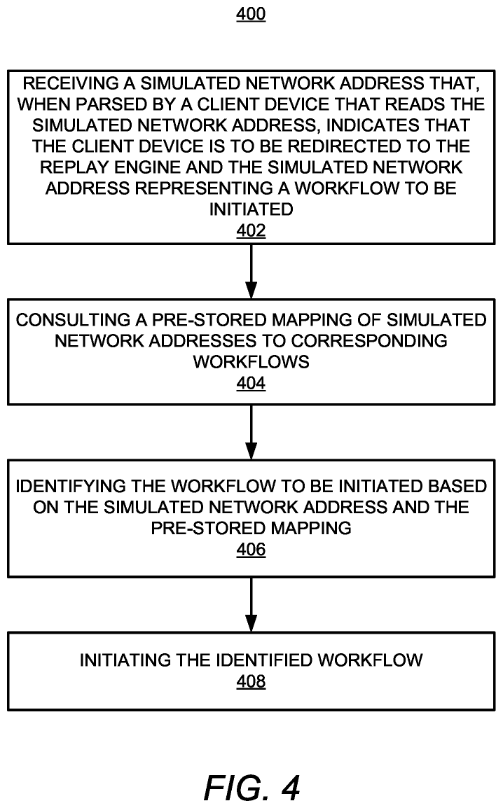

Various manners in which the apparatus 100 may operate to initiate workflows based simulated network addresses are discussed in greater detail with respect to the method 400 depicted in FIG. 4. It should be understood that the method 400 may include additional operations and that some of the operations described therein may be removed and/or modified without departing from the scopes of the method 400. The descriptions of the method 400 may be made with reference to the features depicted in FIGS. 1-3 for purposes of illustration.

FIG. 4 depicts a flow diagram of an example method of initiating automated workflows based on a simulated network address;

As shown in FIG. 4, at block 402, the processor 102 may receive a simulated network address that, when parsed by a client device (such as client device 201 illustrated in FIGS. 2 and 3) that reads the simulated network address, indicates that the client device 201 is to be redirected to the replay engine and the simulated network address representing a workflow to be initiated.

At block 404, the processor 402 may consult a pre-stored mapping of simulated network addresses to corresponding workflows. At block 406, the processor 402 may identify the workflow to be initiated based on the simulated network address and the pre-stored mapping. At block 408, the processor 402 may initiate the identified workflow.

Some or all of the operations set forth in the method 400 may be included as utilities, programs, or subprograms, in any desired computer accessible medium. In addition, the method 400 may be embodied by computer programs, which may exist in a variety of forms. For example, some operations of the method 400 may exist as machine-readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

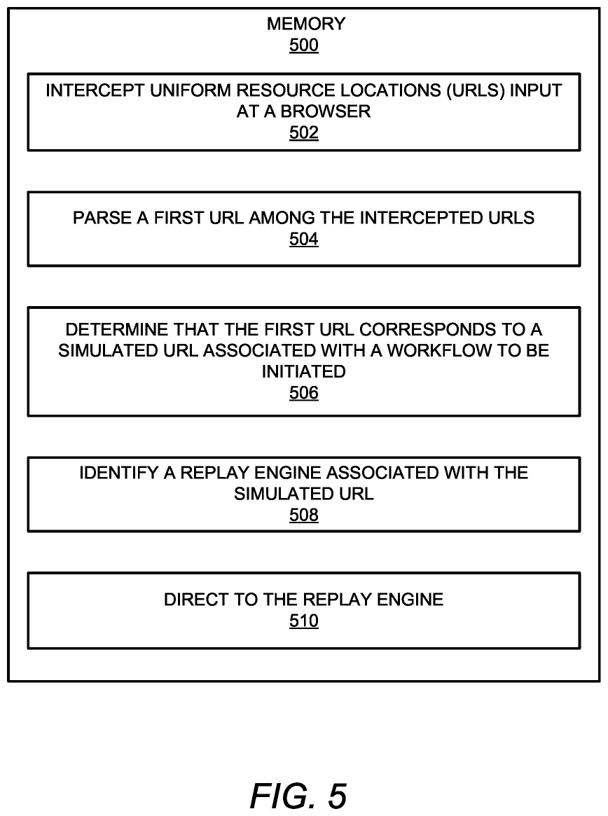

FIG. 5 depicts a block diagram of an example non-transitory machine-readable storage medium 500 for intercepting URLs and redirecting a browser to initiate an automated workflow when an intercepted URL is a simulated URL.

The non-transitory machine-readable storage medium 500 may be an electronic, magnetic, optical, or other physical storage device that includes or stores executable instructions. The non-transitory machine-readable storage medium 500 may be, for example, Random Access memory (RAM), an Electrically Erasable Programmable Read-Only Memory (EEPROM), a storage device, an optical disc, and the like. The non-transitory machine-readable storage medium 500 may have stored thereon machine-readable instructions 502-510 that a processor, such as the processor 202 (illustrated in FIGS. 2 and 3), may execute.

The machine-readable instructions 502 may cause the processor to intercept uniform resource locations (URLs) input at a browser. The machine-readable instructions 504 may cause the processor to parse a first URL among the intercepted URLs. The machine-readable instructions 506 may cause the processor to determine that the first URL corresponds to a simulated URL associated with a workflow to be initiated. The machine-readable instructions 508 may cause the processor to identify a replay engine associated with the simulated URL. The machine-readable instructions 510 may cause the processor to direct the browser to the replay engine.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. An apparatus, comprising:
a processor; and
a non-transitory computer readable medium on which is stored instructions that when executed by the processor, are to cause the processor to:
receive a simulated network address that does not resolve to an actual network resource location, the simulated network address representing a workflow to be initiated;
consult a pre-stored mapping of simulated network addresses to corresponding workflows;
identify the workflow to be initiated based on the simulated network address and the pre-stored mapping; and
initiate the identified workflow.

2. The apparatus of claim 1, wherein to initiate the workflow, the instructions are further to cause the processor to:
identify an automation script associated with the workflow; and
cause the automation script to be executed.

3. The apparatus of claim 2, wherein the instructions are further to cause the processor to:
obtain a parameter from the simulated network address; and
pass the parameter as an input to the automation script.

4. The apparatus of claim 2, wherein the simulated network address is received from a client device, and wherein to cause the automation script to be executed, the instructions are further to cause the processor to:
provide an instruction to the client device to execute the automation script.

5. The apparatus of claim 1, wherein to initiate the workflow, the instructions are further to cause the processor to:
generate a graphical user interface (GUI) associated with the workflow; and
transmit the GUI to a device from which the simulated network address was received.

6. The apparatus of claim 5, wherein to generate the GUI, the instructions are further to cause the processor to:
automatically fill a GUI field with a value based on the simulated network address.

7. The apparatus of claim 6, wherein the instructions are further to cause the processor to:
obtain a parameter from the simulated network address, wherein the value is identified based on the parameter.

8. The apparatus of claim 1, wherein the workflow is associated with a plurality of recorded automation scripts, and wherein to initiate the workflow, the instructions are further to cause the processor to:
identify the plurality of recorded automation scripts based on the simulated network address;
access the plurality of recorded automation scripts from an automation script repository; and
replay the plurality of recorded automation scripts.

9. The apparatus of claim 1, wherein a first portion of the simulated network address indicates that the simulated network address is to be treated as a simulated network address rather than an actual network address and a second portion of the simulated network address identifies the workflow to be executed.

10. A method, comprising:
receiving, by a processor of a device, a simulated network address that, when parsed by a client device that reads the simulated network address, indicates that the client device is to be redirected to a replay engine, wherein the simulated network address represents a workflow to be initiated;
consulting, by the processor, a pre-stored mapping of simulated network addresses to corresponding workflows;
identifying, by the processor, the workflow to be initiated based on the simulated network address and the pre-stored mapping; and
initiating, by the processor, the identified workflow.

11. The method of claim 10, wherein the simulated network address comprises a simulated uniform resource location (URL), the method further comprising:
generating the simulated URL for the identified workflow; and
adding the simulated URL and an association with the identified workflow to the pre-stored mapping.

12. The method of claim 11, wherein generating the simulated URL comprises:
encoding, in a domain name portion of the simulated URL, an indication that the simulated network address is to be treated as such and not an actual network address and encoding an identity of the workflow in a portion of the simulated URL other than the domain name portion.

13. The method of claim 11, wherein generating the simulated URL comprises:
encoding, in a protocol identifier portion of the simulated URL, an indication that the simulated network address is to be treated as such and not an actual network address and encoding an identity of the workflow in a portion of the simulated URL other than the protocol identifier portion.

14. The method of claim 11, wherein generating the simulated URL comprises:
encoding, in a content identifier portion of the simulated URL, an indication that the simulated network address is to be treated as such and not an actual network address and encoding an identity of the workflow in a portion of the simulated URL other than the content identifier portion.

15. The method of claim 11, wherein initiating the identified workflow comprises:
executing an automation script associated with the workflow.

16. The method of claim 15, wherein executing the automation script comprises:
replaying the automation script to automatically fill in an input of a graphical user interface.

17. The method of claim 15, wherein executing the automation script comprises:
executing a backend process that is not visible to a requesting user.

18. A non-transitory computer readable medium (CRM) on which is stored machine readable instructions that when executed by a processor, cause the processor to:
intercept uniform resource locations (URLs) input at a browser;
parse a first URL among the intercepted URLs;
determine that the first URL corresponds to a simulated URL associated with a workflow to be initiated;
identify a replay engine associated with the simulated URL; and
direct the browser to a replay engine to initiate the workflow.

19. The CRM of claim 18, wherein the instructions further cause the processor to:
parse a second URL among the intercepted URLs;
determine that the second URL corresponds to an actual URL; and
direct the browser to browse to the second URL.

20. The CRM of claim 19, wherein the instructions further cause the processor to:
receive, from the replay engine via the browser, an instruction to execute a backend processing operation for the workflow; and
execute the backend processing operation responsive to the instruction.
